(19) United States
(12) Patent Application Publication
(10) Pub. No.: US 2003/0195808 A1
(43) Pub. Date: Oct. 16, 2003

(54) Managing retailer product disbursement

(76) Inventors: Michael Wayne Brown, Georgetown, TX (US); Kelvin Roderick Lawrence, Round Rock, TX (US); Michael A. Paolini, Round Rock, TX (US)

Correspondence Address: BRACEWELL & PATTERSON, L.L.P., P.O. BOX 969, AUSTIN, TX, 78767-0969, US

(21) Appl. No.: 10/435,576

(22) Filed: May 9, 2003

Related U.S. Application Data
(62) Division of application No. 09/560,389, filed on Apr. 28, 2000.

(51) Int. Cl. G06F 17/60

(52) U.S. Cl. 705/14; 705/26

(57) ABSTRACT

In accordance with the method, system and program of the present invention, multiple broadcasts of products are detected in a common transmittable data format at a portable computer system associated with a particular user from multiple retailer server systems when the portable computer system is within a particular proximity of multiple diverse store locations each respectively associated with one of the multiple retailer server systems. The broadcasts of products are analyzed at the portable computer system according to consumer preferences for the particular user. Output of a selection of products from among the multiple broadcasts of products is controlled to an output interface controlled by the portable computer system, in response to the analysis, such that a portable computer system may manage product selections from multiple diverse store locations for a particular user according to the consumer preferences for the particular user.

### CROSS-REFERENCE TO RELATED APPLICATIONS

The present application is related to the following co-pending applications, which are filed on even date herewith and incorporated herein by reference:

(1) U.S. patent application Ser. No. ______ (Attorney Docket No. AUS000039US1); and

(2) U.S. patent application Ser. No. ______ (Attorney Docket No. AUS000040US1).

### BACKGROUND OF THE INVENTION

1. Technical Field

The present invention relates in general to an electronic consumer shopping manager and, in particular, to a method, system and program for electronically managing shopping for a user at multiple diverse retailers. Still more particularly, the present invention relates to a method, system and program for utilizing a single portable computer system to filter products offered by multiple diverse retailers according to user preferences and to guide a user in locating the position of products offered by multiple diverse retailers.

2. Description of the Related Art

As the tide is turning towards a paperless world, computers are becoming more prevalent in order to replace many functions previously performed utilizing paper. In particular, computing devices, such as personal digital assistants, laptop computers and cellular/digital telephones are becoming more commonplace as a personal, portable computer system. Such devices are typically designed to provide reliable and efficient transmittal and storage of data. For example, many digital telephones not only include capabilities to transmit and receive voice data, but to transmit and receive electronic data such as stock quotes, current weather and news. A small is display device is typically provided to display the electronic data.

In the consumer world, web sites accessible via a personal computer are allowing products and services provided to consumers to become more customized. For example, a clothing web site may provide for a user to enter clothing preferences and the clothing web site provides the user with a selection of clothing that meets the user's criteria. In addition, if the user registers with the clothing web site, the web retailer may send electronic mail updates to the user when sales on preferred items are starting. However, while retail web sites provide for user-customization of displays, the user is not provided with the ability to try on the clothing.

In addition, web sites which are accessible via a personal computer are providing bot services. A bot (short for robot) or agent is a program that performs a repetitive, time consuming task, such as searching Web sites and news groups for information and indexing the Web sites and news group listings in a databases or an automatic record-keeping system. For example, a user may utilize a Web site offering a shop bot to search the web for the lowest price for a particular music compact disc (CD). The bot would return a listing of web sites selling the particular CD and the price offered by each site. A user is relieved of the task of going to each web site, searching for the CD and recording the price of the CD at that site. However, while bots provide for gathering consumer provider information in a time-efficient manner, typically bots do not provide for the web retailers to respond with additional specialized products and services according to customer preferences. In addition, in the example of the CD, if a user selects to purchase the CD from a particular site provided by the bot, the user must still enter preferences and personal information to register at the site to make the purchase.

Global positioning systems (GPS) add to the applications of personal, portable computer systems. In the consumer world, as personal computer systems include GPS and communication mediums to connect to a network, personal computer systems may receive regionalized advertising and sale updates. For example, a shopper's eye system, incorporating a personal digital assistant (PDA) equipped with a GPS and wireless Internet Protocol (IP), enables a two-way channel with a central control center through which retailers can present customized offers to nearby shoppers based on their particular interests. In particular, the location of a user, shopping goals, preferences and related history may be detected by a central control center for a mall the user has entered. This information is routed to stores in the mall and as the stores receive this information, they may create a customized offer of bundled goods and services. In addition, manufacturers of competing goods are notified and may respond with incentives to add to the offer. The offer is transmitted from the central control center to the user's PDA.

However, the shopper's eye system does not provide for transmitting store inventories and specials to a user's PDA and filtering store inventories and specials at the user's PDA according to the user's preferences set at the PDA, whereby the user's preferences and identity are protected. In addition, the shopper's eye system does not provide for searching inventories of multiple retailers within a particular proximity of the user's PDA according to a shop bot application. Moreover, the shopper's eye system does not provide a locating function to aid user's in physically locating a particular store or inventoried item.

U.S. Pat. No. 5,751,246 provides for placing a GPS receiver in association with store items such that with the assistance of an electronic shopping assistant, the location of items with GPS receivers can be polled such that user can be directed to the floor, store, aisle or shelf where the item associated with the GPS receiver is located. While U.S. Pat. No. 5,751,246('575) provides a locating function to aid a user in physically locating a particular store or inventoried item, the invention of the '575 patent does not provide for transmission of a complete inventory of items with or without GPS receivers to the electronic shopping assistant. In addition, the invention of the '575 patent does not provide discernment between items, for example, such as those items that are on sale and those items that are not on sale.

In view of the foregoing, it would be desirable to provide a portable computer system through which a user receives customized shopping assistance when visiting the physical venue of a retailer, whereby retail stores can compete with on-line shopping in providing efficient shopping assistance services. It would be advantageous to provide a portable computer system as a personal shopping manager device that includes multiple types of preferences for a user that are utilized to filter retailer inventories and special promotions from multiple diverse retailers. In addition, it would be desirable to provide a shop bot application on the personal shopping manager device that can search both store-based retailer inventories and on-line retailer inventories to provide the user with comparison shopping between a physical store location and virtual store location. Moreover, it would be advantageous to receive positioning data at a user's personal shopping manager device for the location of a store, store personnel, and/or items located in the store such that the user receives directions to find the store, store personnel an/or items located in the store.

### SUMMARY OF THE INVENTION

In view of the foregoing, it is therefore an object of the present invention to provide an improved electronic shopping manager.

It is another object of the present invention to provide an improved method, system and program for electronically managing shopping for a user at multiple diverse retailers.

It is yet another object of the present invention to provide an improved method, system and program for utilizing a single portable computer system to filter products offered by multiple diverse retailers according to user preferences and to guide a user in locating the position of products offered by multiple diverse retailers.

In accordance with the method, system and program of the present invention, multiple broadcasts of products are detected in a common transmittable data format at a portable computer system associated with a particular user from multiple retailer server systems when the portable computer system is within a particular proximity of multiple diverse store locations each respectively associated with one of the multiple retailer server systems. The broadcasts of products are analyzed at the portable computer system according to consumer preferences for the particular user. Output of a selection of products from among the multiple broadcasts of products is controlled to an output interface controlled by the portable computer system, in response to the analysis, such that a portable computer system may manage product selections from multiple diverse store locations for a particular user according to the consumer preferences for the particular user.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts one embodiment of a data processing system with which the method, system and program of the present invention may advantageously be utilized;

FIG. 2 illustrates one embodiment of a high level block diagram of an electronic shopping management system in accordance with the method, system and program of the present invention;

FIG. 3 depicts one embodiment of a detailed block diagram of an electronic shopping management system in accordance with the method, system and program of the present invention;

FIG. 4 illustrates a high level logic flowchart of a process and program for controlling a retailer server system in accordance with the present invention; and

FIG. 5 depicts a high level logic flowchart of a process and program for controlling a portable computer system in accordance with the present invention.

### DETAILED DESCRIPTION OF PREFERRED EMBODIMENT

The present invention may be executed in a variety of systems, including a variety of computing systems and electronic devices under a number of different operating systems. In a preferred embodiment of the present invention, the computer system is a portable computing system such as a notebook computer, a palmtop computer, a personal digital assistant, a telephone or other electronic computing system. Such as device that may also incorporate communication features that provide for telephony, enhanced telephony, messaging and information services. However, the computer system may also be, for example, a desktop computer, a network computer, a midrange computer or a mainframe computer. Preferably, in order to enable at least one of these communication features, the computer system is able to be connected to a network, such as the Internet by either a wired link or wireless link. In addition, the computer system may be a stand-alone system or part of a network such as a local-area network (LAN) or a wide-area network (WAN). Therefore, in general, the present invention is preferably executed in a computer system that performs computing tasks such as manipulating data in storage that is accessible to the computer system. In addition, the computer system includes at least one output device and at least one input device.

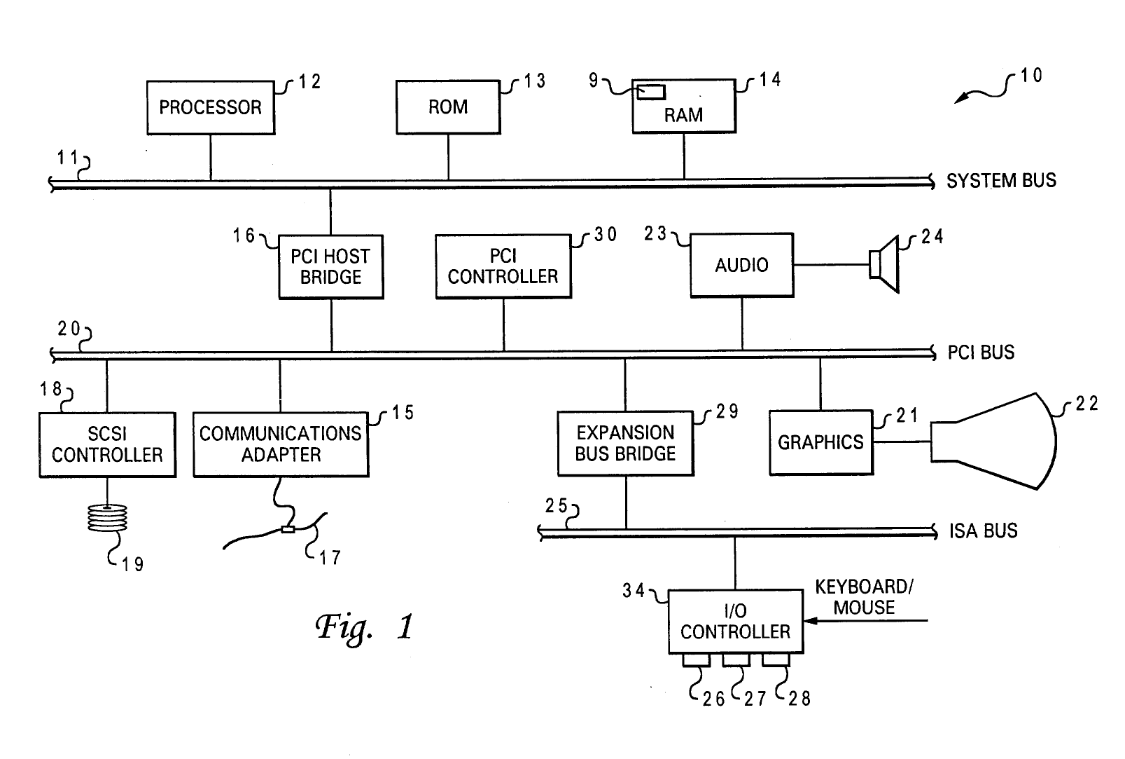

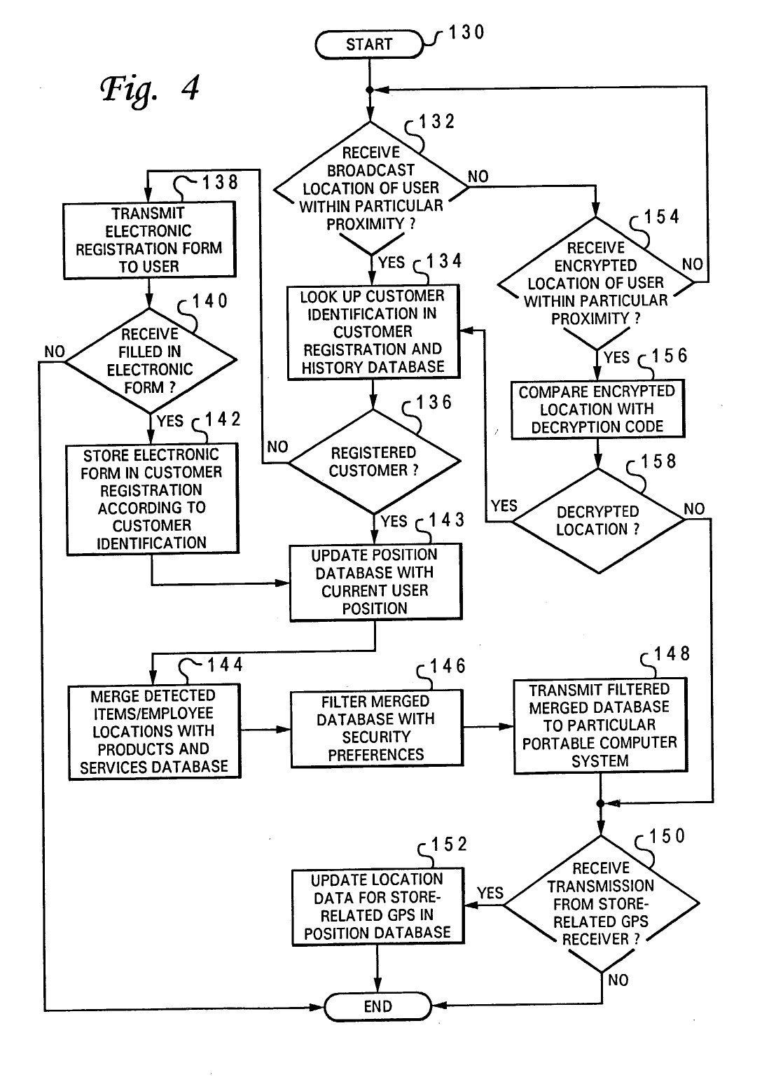

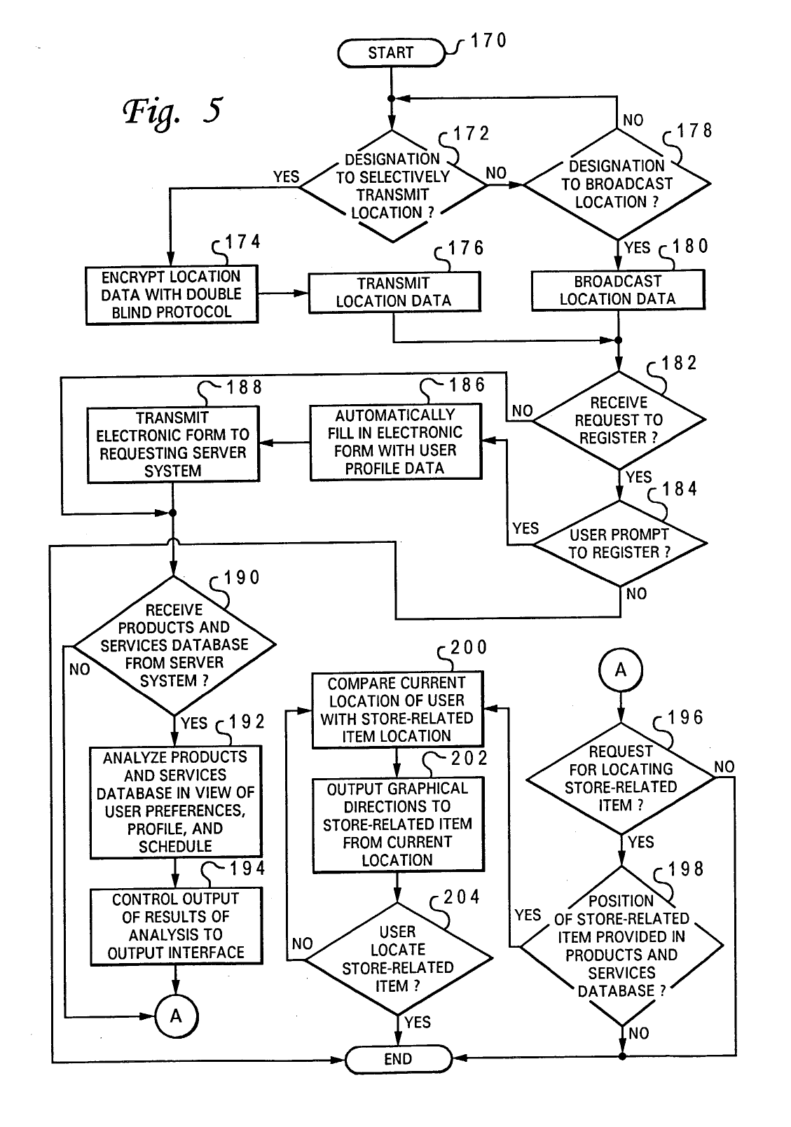

Referring now to the drawings and in particular to FIG. 1, there is depicted a block diagram of one embodiment of a computer system that may utilize the present invention. As depicted, data processing system 10 includes at least one processor 12, which is coupled to system bus 11. Each processor 12 is a general-purpose processor, such as IBM's PowerPC™ processor that, during normal operation, processes data under the control of operating system and application software stored in random access memory (RAM) 14 and Read Only Memory (ROM) 13. The operating system preferably provides a graphical user interface (GUI) to the user. Application software contains instructions that when executed on processor 12 carry out the operations depicted in the flowcharts of FIGS. 4, 5 and others described herein.

Processors 12 are coupled via system bus 11 and Peripheral Component Interconnect (PCI) host bridge 16 to PCI local bus 20. PCI host bridge 16 provides a low latency path through which processor 12 may directly access PCI devices mapped anywhere within bus memory and/or I/O address spaces. PCI host bridge 16 also provides a high bandwidth path for allowing PCI devices to directly access RAM 14.

PCI local bus 20 interconnects a number of devices for communication under the control of PCI controller 30. These devices include a Small Computer System Interface (SCSI) controller 18, which provides an interface to SCSI hard disk 19, and communication adapter(s) 15, which interface data processing system 10 to at least one data communication network 17 comprising wired and/or wireless network communication. In addition, an audio adapter 23 is attached to PCI local bus 20 for controlling audio output through speaker 24. A graphics adapter 21 is also attached to PCI local bus 20 for controlling visual output through display monitor 22. In alternate embodiments of the present invention, additional peripheral components may be added. For example, in alternate embodiments, a tactile display component may be provided.

PCI local bus 20 is further coupled to an Industry Standard Architecture (ISA) bus 25 by an expansion bus bridge 29. As shown, ISA bus 25 has an attached I/O (Input/Output) controller 34 that interfaces data processing system 10 to peripheral input devices such as a keyboard and mouse (not illustrated) and supports external communication via parallel, serial and universal serial bus (USB) ports 26, 27, and 28, respectively.

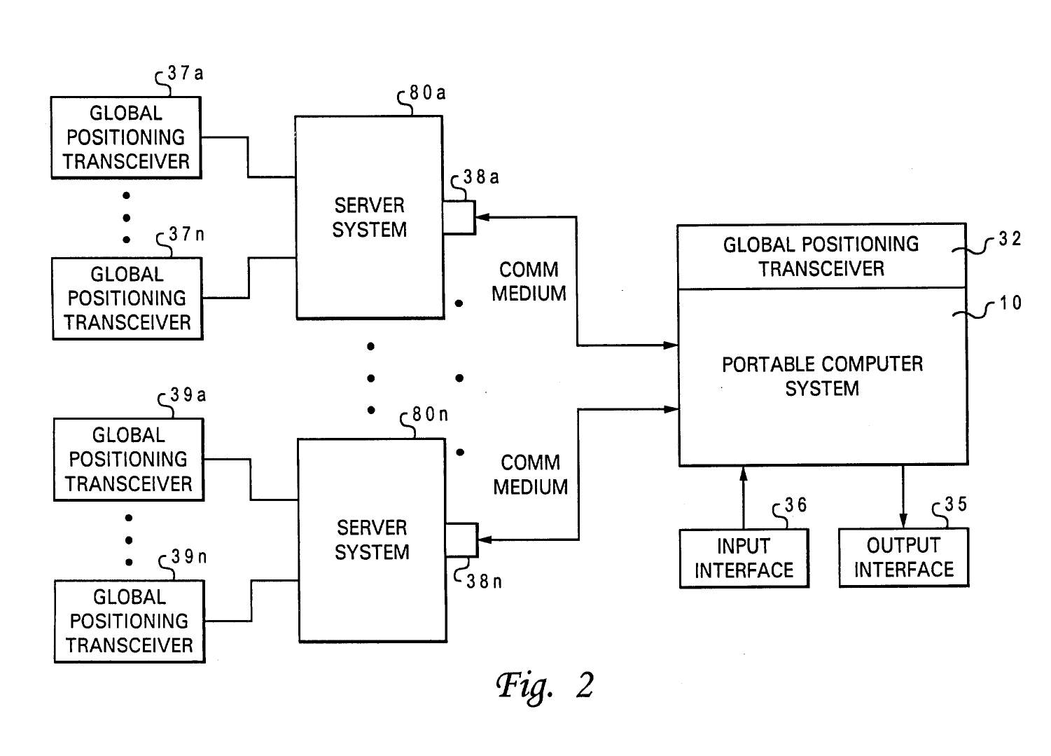

With reference now to FIG. 2, there is illustrated one embodiment of a high level block diagram of an electronic shopping management system in accordance with the method, system and program of the present invention. As depicted, a portable computer system 10 that includes multiple diverse consumer preferences for at least one user communicates with multiple diverse server systems 80a-80n via a communication medium (or across a communication interface). The communication medium may include wired or wireless communication or other communication media that enables transmission of data. Moreover, the communication medium may include a link to a network, such as the Internet, or a straight data link. Furthermore, data may be transmitted from server systems 80a-80n to an electronic mail address that is accessible to portable computer system 10.

Data exchange across the communication medium is advantageously performed in at least one of multiple available data transmission protocols and is preferably supported by a common data structure format, such as the extensible mark-up language (XML) data structure format. Data transmission protocols may include, but are not limited to, Transmission Control Protocol (TCP), Internet Protocol (IP), Hypertext Transfer Protocol (HTTP), and Bluetooth. In addition, data may be transmitted in a secure manner via encryption or by technologies, such as secure socket layer (SSL) or virtual private networks (VPN).

An example of a portion of an XML data file of a database of products that might be transmitted from server systems 80a-80n to portable computer system 10, as depicted below, preferably contains data that is distinguished by attributes on elements and may be wrappered within a larger element. For example, the data attributed to element “<TimeStamp> </TimeStamp>” designates the time that the data was attributed to the XML data file.

<PRODUCTS TimeStamp=“888965153” MachineID=“56.342.34.1” StoreLocation=“123.5,34.5” LocationName=“RetailerA-SouthAustin” SpecOffer=“Red Jacket for $20 off” SpecOfferGraph=“jacket.jpg” Clothing=“Jacket1” ClothingColor=“Red, Blue, Black” ClothCost=“40.00” ClothSize=“Womens:S, M, L”>

In addition, in an alternate example, the XML data file might be formatted utilizing elements, as illustrated below.

<TimeStamp>888965153</TimeStamp>

<MachineID>56.342.34.1</MachineID>

<StoreLocation>123.5,34.5</StoreLocation>

<LocationName>RetailerA-SouthAustin</LocationName>

<SpecOffer>Red Jacket for $20 off</SpecOffer>

<SpecOfferGraph>jacket.jpg</SpecOfferGraph>

<Clothing>Jacket1</Clothing>

<ClothingColor>Red, Blue, Black</ClothingColor>

<ClothCost>40.00</ClothCost>

<ClothSize>Womens:S, M, L</ClothSize>

In the example, as will be further described, portable computer system 10 would receive the example XML data file and filter the XML data file according to consumer preferences accessible on computer system 10. In the example, the machine ID of the server system, the location of a venue by latitude and longitude, and a location name for the store in which the products are stocked is included. In addition, a special offer of a red jacket is included with a graphical image for the red jacket attached. Moreover, descriptors of a jacket1 are included in red, blue, black and yellow for $40.00 in women's sizes S, M, and L. The elements, format of the elements, and data included with the elements is provided to depict an example and is not intended to limit the types of elements, format of elements, or data included with elements that are in an XML data file.

In the example of the XML data format as the common transmittable data format, a data validation file such as a document type definition (DTD) or schema is preferably utilized to validate XML data files. In addition, a schema preferably translates multiple XML data files. Moreover, a style sheet such as an extensible stylesheet language (XSL) file is preferably utilized to provide a style specification for the XML data at the receiving system. In particular, DTDs, schemas, and XSL files may be, for example, transmitted with an XML data file to a receiving system or downloaded at the receiving system from an alternate source. In the present example, the DTD or schema would verify that all the data required for transmittal to portable computer system 10 are included in the XML data file.

Server systems 80a-80n preferably represent diverse independent retailers, consumer providers, non-profit organizations and individual proprietors that are enabled to independently broadcast products to portable computer system 10. However, server systems 80a-80n may also communicate via a network connection, such as the Internet. Moreover, each of server systems 80a-80n may include multiple servers connected via a network or data link with access to multiple data storage media.

Server systems 80a-80n are advantageously enabled to broadcast multiple products that are accessible at a particular store location associated with the server system. In the present embodiment, server systems 80a-80n may be equipped respectively with transceivers 38a-38n by which multiple products are broadcast in a common transmittable data format, such as XML, as previously described. Each of transceivers 38a-38n may provide multiple ranges of transmission and reception. In addition, each of transceivers may be locally or remotely associated with server systems 80a-80n. For example, a server system may be located in New York, however a transceiver that is remotely accessible to the server system may be located in association with a store in a city in Wisconsin. A product broadcast from the remotely accessible transceiver may focus on products available at the store in Wisconsin. In an alternate embodiment, server systems 80a-80n may broadcast products via a network connection to all computer systems that are detected with a particular location of transceivers 38a-38n. For example, portable computer system 10 detected with a particular proximity of the remotely accessible transceiver in Wisconsin will receive a broadcast of products from a network connection accessible by the server system in New York.

In broadcasting multiple products, the positions of multiple products may selectively be included. In a preferred embodiment of the present invention, products and personnel may each be equipped with a global positioning system (GPS) transceiver that passively receives a position and transmits that position to one of server systems 80a-80n. For example, GPS transceivers 37a-37n passively detect and transmit the location of products and personnel to server system 80a and GPS transceivers 39a-39n detect and transmit the location of products and personnel to server system 80n. GPS transceivers 37a-37n and 39a-39n preferably transmit locations in a common transmittable data format and may encrypt the data utilizing a particular transmittable protocol such that only a particular server system is enabled to receive the locations.

Product broadcasts from server systems 80a-80n are preferably detected by portable computer system 10 via a transceiver 32. Transceivers 32 may detect the location of server systems 80a-80n from the broadcast. Alternatively, the locations of server systems 80a-80n may be included in the product broadcasts. Transceiver 32 may further include GPS functions such that the position of portable computer system 10 is passively detected and may be transmitted to server systems 80a-80n.

Portable computer system 10 advantageously includes multiple consumer preferences for a particular user which are utilized to filter product broadcasts from multiple diverse server systems, such as server systems 80a-80n. As will be further described, product broadcasts may be filtered with consumer preferences for a particular user according to a bot application accessible to portable computer system 10. In addition, product broadcasts may be filtered with consumer preferences according to a preference filter application that selects products to display to the particular user according to the multiple consumer preferences.

In addition, portable computer system 10 preferably includes at least one input interface 36 and at least one output interface 35 coupled thereto. A user may view a filtered selection of products via output interface 35. In addition, a user may indicate intended purchases from among the filtered selection of products via input interface 36. A user may select to broadcast the position of portable computer system 10 via a selection at input interface 36. Moreover, a user may provide consumer preferences to portable computer system 10 via a personal storage device, such as a smart card. In particular, portable computer system 10 may be provided to a consumer whereby the consumer provides access to consumer preferences at portable computer system 10 via the user's personal storage device.

Input interface 36 may include multiple types of input interfaces including, but not limited to, a keyboard, a keypad, a vocal recognition device, a touchpad, a mouse, a tactile-detectable device, etc. Output interface 35 may include multiple types of output interfaces including, but not limited to, a graphical display monitor, a printer, a data storage medium, an audio speaker, etc. In particular, computer system 10 may control multiple output interfaces where different output interfaces have different audiences and purposes, as will be further described.

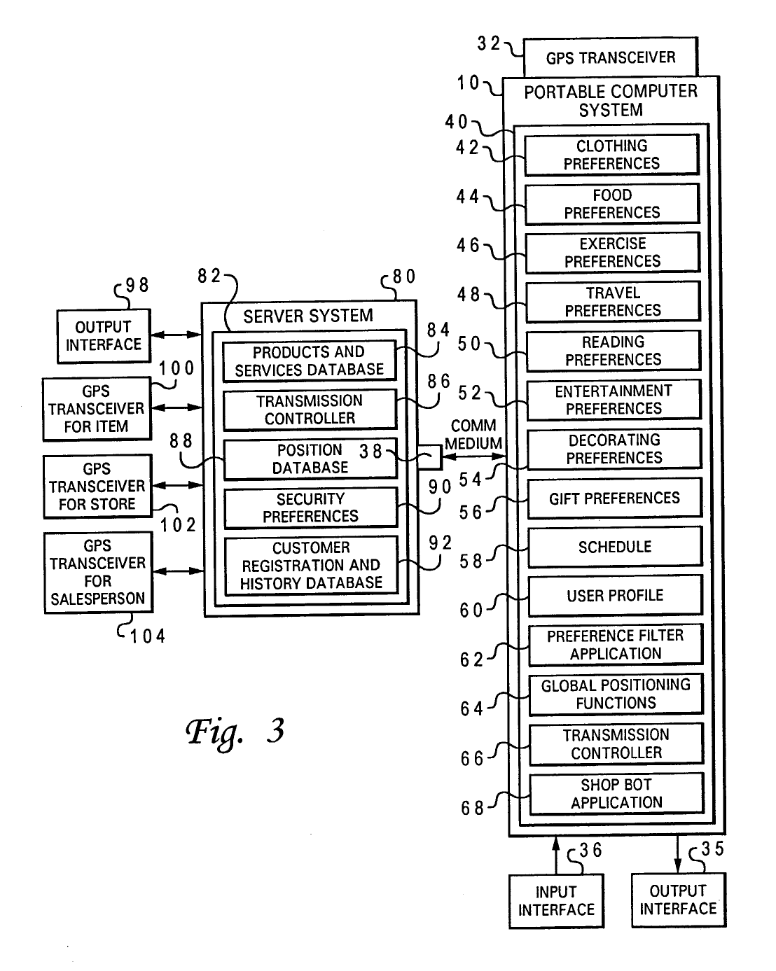

Referring now to FIG. 3, there is depicted a block diagram of an electronic shopping management system in accordance with the method, system and program of the present invention. Server system 80 preferably supports electronic business for a particular retailer or consumer provider. In the present example, server system 80 includes electronic business related data, services and applications stored in a data storage medium 82 including a products and services database 84, a transmission controller application 86, a position database 88, security preferences 90, and customer registration and history database 92. The databases are preferably data storage structures that hold multiple entries and may be searched and/or filtered according to particular criteria. In addition, data stored in the databases is easily convertible into an XML data file. Moreover, in an alternate embodiment, alternate types of data may be stored in data storage medium 82. Moreover, in an alternate embodiment, additional services and applications may be stored in data storage medium 82.

Server system 80 controls exchange of data to and from multiple portable computer systems, such as portable computer system 10, via a transmission controller 86 that may control transmission of data via both transceiver 38 and a network interface. Filtered selections of products and services from products and services database 84 may be broadcast from server system 80 as controlled by transmission controller 86. In addition, positions and registration indicators of potential customers broadcast from a portable computer system, such as portable computer system 10, may be detected via transceiver controller 86.

Customer registration and history database 92 preferably includes registration data for each registered customer. Customers may register by transmitting registration data from portable computer system 10 to server system 80. In addition, in registering, a registration indicator, such as a registration cookie, may be transmitted for storage on portable computer system 10. In detecting the registration indicator, the user's registration data would be retrieved from customer registration and history database 92. In addition, customer registration and history database 92 preferably includes history of purchases and visits by the user to the retailer or consumer provider. Moreover, the history of purchases and visits to an on-line location of the retailer may be recorded in customer registration and history database 92.

Server system 80 controls output of data to multiple diverse output interfaces, such as output interface 98. Transmission of data to output interfaces 98 may travel via a wired or wireless communication medium. The diverse output interfaces may include, but are not limited to, output interfaces within a store for advertising, output interfaces within a store for displaying data to employees only, output interfaces within a shopping arena, and output interfaces along a road-side. Output interface 98 may include multiple diverse types of output devices including, but not limited to, flat-screen monitors, LCD graphical displays, electronic paper displays, electronic billboard displays, tactile-detectable displays, audio speakers, printers, and other forms of electronic media output devices.

Position database 88 preferably includes the physical location of multiple GPS, transceivers. In the present example, the physical location of a GPS transceivers for item 100, a GPS transceivers for store 102 and a GPS transceivers for salesperson 104 are preferably detected by server system 80. In addition to including a current position for item 100, store 102 and salesperson 104, a range of area within which item 100, store 102, and salesperson 104 should be located may also be included. In the event that the GPS transceivers associated with item 100, store 102, or salesperson 104 leaves the designated range of area, an alarm may be sounded or other security measures may be initiated. For example, unauthorized movement of a kiosk in a mall would be monitored and security initiated. In an alternate embodiment, locations of items, stores and employees may be entered via an input interface (not shown) to server system 80.

Products and services database 84 preferable includes multiple diverse products and/or services provided by a retailer or consumer provider. The products and services may include, for example, multiple types of descriptors, prices and conditions. For example, a women's formal dress store may include a database of available dresses, with a description of the maker, dress style and color, pictures of the dress, sizes available and price. In addition, for each available dress, a list of the events for which the dress has already been purchased may be stored. In addition, the database may include service records such as schedules of consultants within the dress store and their availability for a consultation reservation. Moreover, the database may include a listing and pictures of an expected shipment of dresses that are viewable on the condition that a customer has made previous purchases at the store.

Position database 88 and products and services database 84 may cross-reference one another. For example, the item associated with GPS transceiver for item 100 stored in products and services database 84 is cross-referenced according to position in position database 88. In addition, the data included in position database 88 and products and services database 84 may be filtered and secured according to security preferences 90. Security preferences 90 may designate to only allow a user to receive the location of products during business hours at the user's portable computer system 10. In another example, security preferences 90 may designate that portable computer system 10 must be within a particular proximity to receive the location of products. Moreover, security preferences 90 may designate that the location of products that cost less than a particular amount can be received by a user. Furthermore, security preferences 90 may designate which products and services are limited to customers included in customer registration and history database 92. In yet another example, security preferences 90 may designate that only products which are designated as being on-sale are transmittable.

Effectively, transmission controller 86 may broadcast a filtered selection of products and services database 84, such that any portable computer system is enabled to receive the products and service broadcast when within a particular proximity of a transceiver 38. Alternatively, transmission controller 86 may selectively transmit a filtered selection from products and services database 84 to a particular portable computer system.

When portable computer system 10 is within a particular proximity of a transmission from transceiver 38 of server system 80, a product broadcast filtered according to security preferences 90 comprising products and services and locations of stores, items and employees is transmitted to portable computer system 10. Product broadcasts received at portable computer system 10 are preferably filtered according to multiple consumer preferences. In addition, the product broadcasts may be stored in a data storage medium 40 or portable computer system 10. In the present example, data storage medium 40 is depicted as internally accessible to portable computer system 10, however in alternate embodiments, data storage medium 40 may be accessible externally or remotely. Moreover, data storage medium 40 may be accessible via a network.

In the example depicted, customer preferences include clothing preferences 42, food preferences 44, exercise preferences 46, travel preferences 48, reading preferences 50, entertainment preferences 52, decorating preferences 54, and gift preferences 56. Included in the customer preferences may be a shopping list of items to find, budget preferences, location preferences, content preferences, customer service preferences, etc. For example, clothing preferences 42 may include preferred manufacturers, sizes, colors, clothing types for upcoming events, budget constraints, etc. while reading preferences 50 include a list of books to purchase, preferred types of literature, authors, current readings, etc. Food preferences 50 may include preferences for food items, and may also include preferences such as seating at a table in a corner, having a particular wine served when seated, etc.

While these preferences represent many of the consumer preferences that may be designated by a user at portable computer system 10, the consumer preferences depicted are intended to illustrate possible preferences and do not limit the types of consumer preferences which may be stored on data storage medium 40. Moreover, the preferences may be stored in multiple types of formats and may be compiled and sorted according to multiple criteria. For example, a list of items to find at a particular shopping center may be sorted.

In addition, preferences are preferably storable on portable computer system 10 for other people or clients. Moreover, consumer preferences are preferably transmittable from one portable computer system to another portable computer system. For example, a decorator may include a list of decorating preferences for multiple clients within decorating preferences 54 of the decorator's portable computer system, where the decorating preferences for multiple clients are transmitted from the client's portable computer system to the decorator's portable computer system. In another example, a parent may include a list of children's clothing preferences in clothing preferences 42 of the parent's portable computer system.

In addition to including preferences on portable computer system 10, the user's schedule 58 and user profile 60 are preferably included. The user's schedule 58 preferably includes an electronic calendar of events, appointments and tasks. In addition, an electronic address book and other electronic personal management tools may be included with the user's schedule 58. User profile 60 preferably includes personal data about the user such as name, home data, work data, payment account information, marital status, primary language, children, etc. In addition, user profile 60 may include registration identifiers for various retailers as a result of the user registering with multiple retailers.

Moreover, portable computer system 10 includes global positioning functions 64. Global positioning functions 64 utilize data retrieved from GPS transceiver 32 to determine information about surroundings including traffic, descriptions of stores and offices, etc. In addition positional data, such as a fastest walking or driving path, may be determined by global positioning functions 64.

In addition, global positioning functions 64 includes a designation to broadcast the location of portable computer system 10 and registration indicators via GPS transceiver 32. Alternatively, global positioning functions 64 may include a designation to selective transmit the location of portable computer system 10 and selective registration indicators to a 10 selection of server systems from among server systems 80a-80n. In selectively transmitting a location, the location may be encrypted by a functions, such as double-blind encryption.

Portable computer system 10 includes a preference filter application 62 that analyzes the database of products and services received from server system 80 in view of consumer preferences, schedule 58, user profile 60 and current location to provide the user with recommended shopping venues. The results of analysis are preferably presented to the user via output interface 35 in a preferred output format as designated in user profile 60. For example, a user may request that the results of analysis are output in a large font or in colors acceptable for a color-blind viewer.

Moreover, preference filter application 62 preferably has access to a map via global positioning functions 64 such that the user's current location in comparison with retailers and other offices can be determined. Preference filter application 62 may analyze the database of products and services received from various retailers in accordance with the location, expected travel time, schedule and other data to provide a recommendation of stores with directions and estimated travel time. For example, if a user's food preferences 44 include a grocery list that includes speciality Asian cooking products and two Asian grocery stores providing the specialty cooking products are detected within a particular area, preference filter application 62 would analyze the prices offered by each grocery store and the travel time in comparison with whether time or money is a larger constraint for the user to recommend one of the two Asian grocery stores.

In addition, portable computer system 10 advantageously includes a shop bot application 68 that is executable on portable computer system 10. Shop bot application 68 preferably searches databases of products and services received from multiple diverse retailers for a particular items or items. In particular, shop bot application 68 not only searches products and services received from multiple retailers because of proximity to the retailers, but searches products and services accessible via web sites. Therefore, a list of prices and stores is determined at computer system 10 that preferably includes both retailers with store fronts within a particular proximity and online retailers. The list of prices and stores may further be utilized by preference filter application 62 to determine cost and time comparisons of going to a listed store front versus a listed online retailer.

A user may select to electronically purchase a product or service that is identified in a transmission to portable computer system 10 from server system 80 when the user is within a particular proximity of transceiver 38 of server system 80. The user may select to have the product or service delivered to the user or the user may opt to receive the product or service at the retailer's store front.

While the present invention may be applied to any server system 80 in communication with a portable computer system 10, multiple examples are provided in order to further describe the functions of the present invention. In an example of the present invention, a server system includes products and services provided by a car dealership. Each of the cars and car salesmen includes a global positioning system receiver. Upon stepping onto the car lot, a transceiver associated with the lot's server system detects a user's portable computer system and registration identifier. A car salesman located near the user is notified of the user's presence. The location of the salesman is shielded from the user by the lot's server system, however the user's portable computer system receives a listing of all the cars available on the lot from the lot's server system, including the position of the cars in the lot. The user has designated that the car selections should be narrowed according to a particular price range, number of miles and age of the car. The preference filter application analyzes the listing of all the cars available and presents the user with a selection of cars that meet the preferences of the user. In addition as the user designates different cars on the list, a map showing the location of the car in the lot is provided. In addition, a description of the car mileage and specifications is provided.

In another example, a server system includes products and services provided by a ski resort. When the user is within a particular proximity of the ski slope, a database of maps, run descriptions, restaurants, rental shops and other products and services is provided at the user's portable computer system from the resort server system. The database is analyzed in view of the user's ski slope preferences, food preferences and rental preferences. A rental shop with a preferred type of ski, a selection of restaurants that meet user food preferences and a map with designated ski slopes and lifts is advantageously provided as a result of analysis at the portable computer system. In addition, a location for each of the ski slopes, restaurants, ski patrol office, etc. is preferably accessible to the user whereby the user may navigate when on the mountain.

With reference now to FIG. 4, there is depicted a high level logic flowchart of a process and program for controlling a retailer server system in accordance with the present invention. As illustrated, the process starts at block 130 and thereafter proceeds to block 132. Block 132 depicts a determination as to whether or not the location of a user within a particular proximity is received. If a location of a user within a particular proximity is not received, then the process passes to block 154. If a location of a user within a particular proximity is received, then the process passes to block 134. Block 154 illustrates a determination as to whether or not an encrypted location transmission of a user within a particular proximity is received. If an encrypted location transmission is not received, then the process passes to block 132. If an encrypted location transmission is received, then the process passes to block 156. Block 156 depicts comparing the encrypted location with a decryption code. Thereafter, block 158 illustrates a determination as to whether or not a decrypted location is determined. If a decrypted location is determined, the process passes to block 134. If a decrypted location is not determined, then the process passes to block 150.

Block 134 illustrates looking up the customer location identification in the customer registration and history database. Preferably, a customer location identification for the GPS transceiver is transmitted with the location. Next, block 136 depicts a determination as to whether or not the user is a registered customer. If the user is a registered customer, then the process passes to block 143. If the user is not a registered customer, then the process passes to block 138. Block 138 illustrates transmitting an electronic registration form to the user's portable computer system. Next, block 140 depicts a determination as to whether or not an acceptable electronic form is received while the user is located within the proximity. If an acceptable electronic form is not received, then the process ends. If an acceptable electronic form is received, then the process passes to block 142. Block 142 illustrates storing the electronic form with the customer location identification in the customer registration database; and the process passes to block 143.

Block 143 illustrates updating the position database with the user's current location. The position database may then be continually updated without verifying the user's registration. Block 144 depicts merging the detected items and employee locations with the products and services database. Next, block 146 illustrates filtering the merged database with security preferences. Thereafter, block 148 depicts transmitting the filtered merged database to the user's portable computer system; and the process passes to block 150.

Block 150 illustrates a determination as to whether or not transmission from a store-related GPS transceiver is received at the server system. If a transmission from a store-related GPS transceiver is not received, then the process ends. If a transmission from a store-related GPS transceiver is received, then the process passes to block 152. Block 152 depicts updating the location data for the store-related GPS transceiver in the position database; and the process ends.

Referring now to FIG. 5, there is illustrated a high level logic flowchart of a process and program for controlling a portable computer system in accordance with the present invention. As depicted, the process starts at block 170 and thereafter proceeds to block 172. Block 172 illustrates a determination as to whether or not a designation to selectively transmit the portable computer system location is set. If a designation to selectively transmit location is not set, then the process passes to block 178. If a designation to selectively transmit location is set, then the process passes to block 174. Block 174 depicts encrypting the location data with the double blind protocol. Next, block 176 illustrates transmitting the location data such that only those server systems with include the decryption key can read the transmitted location data; and the process passes to block 180.

Returning to block 178, there is depicted a determination as to whether or not a designation to broadcast the location is set. If a designation to broadcast the location is not set, then the process passes to block 172. If a designation to broadcast the location is set, then the process passes to block 180. Block 180 illustrates a determination as to whether or not a request to register and electronic form is received. If a request to register is not received, then the process passes to block 190. If a request to register is received, then the process passes to block 184. Block 184 depicts a determination as to whether or not a user prompt to register automatically is received. If a user prompt to register automatically is not received, then the process ends. If a user prompt to register automatically is received, then the process passes to block 186.

Block 186 depicts automatically filling in an electronic form received from the server system with the user profile data and preferences. In particular, data which is stored in the XML data format can be easily translated into an electronic form that is in the XML data format by matching tags associated with data. Next, block 188 illustrates transmitting the electronic form to the requesting server system; and the process passes to block 190. In particular, the electronic form may also be encrypted before transmission.

Block 190 illustrates a determination as to whether or not a products and services database is received from a server system. If a products and services database is not received, then the process passes to block 196. If a products and services database is received, then the process passes to block 192. Block 192 depicts analyzing the products and services database in view of user preferences, profiles, schedule, other products and services databases from proximate and on-line retailers, and shop bot application analysis. Thereafter, block 194 illustrates controlling output of the results of analysis to an output interface; and the process passes to block 196.

Block 196 depicts a determination as to whether or not a request for locating a store-related item is received. If a request for locating a store-related item is not received, then the process ends. If a request for locating a store-related item is received, then the process passes to block 198. Block 198 illustrates a determination as to whether or not the position of the store-related item is provided in the products and services database received at the portable computer system. If the position of the store-related item is not received, then the process ends. If the position of the store-related item is received, then the process passes to block 200. Block 200 depicts comparing the current location of the user with the store-related item location. Next, block 202 illustrates controlling output of graphical directions to the store-related item from the current location. Thereafter, block 204 depicts a determination as to whether or not the user has located the store-related item. If the user has not located the store-related item, the process passes to block 200. If the user has located the store-related item, then the process ends.

It is important to note that, although the present invention has been described in the context of a fully functional computer system, those skilled in the art will appreciate that the mechanisms of the present invention are capable of being distributed as a program product in a variety of forms, and that the present invention applies equally regardless of the particular type of signal-bearing media utilized to actually carry out the distribution. Examples of signal-bearing media include, but are not limited to, recordable-type media such as floppy disks or CD-ROMs and transmission-type media such as analogue or digital communication links.

While the invention has been particularly shown and described with reference to a preferred embodiment, it will be understood by those skilled in the art that various changes in form and detail may be made therein without departing from the spirit and scope of the invention.

What is claimed is:

1. A method for electronically managing shopping, said method comprising the steps of:
detecting a plurality of broadcasts of products in a common transmittable data format at a portable computer system associated with a particular user from a plurality of retailer server systems when said portable computer system is within a particular proximity of a plurality of diverse store locations each respectively associated with one of said plurality of retailer server systems;
analyzing said plurality of broadcasts of products at said portable computer system according to consumer preferences for said particular user; and
controlling output of a selection of products from among said plurality of broadcasts of products to an output interface controlled by said portable computer system, in response to said analysis, such that said portable computer system manages product selections from said plurality of diverse store locations for said particular user according to said consumer preferences for said particular user.

2. The method for electronically managing shopping according to claim 1, said step of detecting a plurality of broadcasts of products in a common transmittable data format at a portable computer system, further comprising the step of:
detecting said plurality of broadcasts of products in an extensible mark-up language data format.

3. The method for electronically managing shopping according to claim 1, said step of analyzing said plurality of broadcasts of products at said portable computer system according to consumer preferences for said particular user, further comprising the step of:
analyzing said plurality of broadcasts of products in view of an electronic schedule of events stored on said portable computer system in association with said particular user.

4. The method for electronically managing shopping according to claim 1, said step of analyzing said plurality of broadcasts of products at said portable computer system according to consumer preferences for said particular user, further comprising the step of:
analyzing said plurality of broadcasts of products in view of previously received product databases received at said portable computer system.

5. The method for electronically managing shopping according to claim 1, said step of analyzing said plurality of broadcasts of products at said portable computer system according to consumer preferences for said particular user, further comprising the step of:
analyzing said plurality of broadcasts of products in view of travel distance from a current location to each of said plurality of diverse store locations.

6. The method for electronically managing shopping according to claim 1, said step of analyzing said plurality of broadcasts of products at said portable computer system according to consumer preferences for said particular user, further comprising the step of:
analyzing said plurality of broadcasts of products according to a shopping robot application that searches said plurality of broadcasts of products and a plurality of network accessible web sites to return selections of a particular type of product to said particular user.

7. The method for electronically managing shopping according to claim 1, said step of controlling output of a selection of products from among said plurality of broadcasts of products to an output interface controlled by said portable computer system, further comprising the step of:
controlling output of said selection of products to said output interface according to output preferences designated by said user on said portable computer system.

8. The method for electronically managing shopping according to claim 1, said method further comprising the step of:
broadcasting a location of said portable computer system, in response to a user designation to broadcast said location, such that any of said plurality of retailer server systems within a particular proximity is enabled to detect said location of said portable computer system.

9. The method for electronically managing shopping according to claim 1, said method further comprising the step of:
encrypting transmission of a location of said portable computer system, in response to a user designation to selectively transmit said location, such that only those server systems with a decryption key are enabled to detect said location of said portable computer system.

10. The method for electronically managing shopping according to claim 1, said method further comprising the steps of:
receiving a user request at said portable computer system for assistance in locating a particular venue-related item from among a plurality of venue-related items associated with a particular store location from among said plurality of diverse store locations;
searching said plurality of broadcasts of products received at said portable computer system for a location of said particular venue-related item;
comparing said location of said particular venue-related item with a current location of said portable computer system, in response to determining said location of said particular venue-related item; and
adjusting output of a graphical representation of directions for said user to reach said location of said particular venue-related item from said current location of said portable computer system.

11. The method for electronically managing shopping according to claim 1, said method further comprising the step of:
receiving said consumer preferences at said portable computer system from a personal storage device proffered by said particular user.

12. A system for electronically managing shopping, said system comprising:
means for detecting a plurality of broadcasts of products in a common transmittable data format at a portable computer system associated with a particular user from a plurality of retailer server systems when said portable computer system is within a particular proximity of a plurality of diverse store locations each respectively associated with one of said plurality of retailer server systems;
means for analyzing said plurality of broadcasts of products at said portable computer system according to consumer preferences for said particular user; and
means for controlling output of a selection of products from among said plurality of broadcasts of products to an output interface controlled by said portable computer system, in response to said analysis, such that said portable computer system manages product selections from said plurality of diverse store locations for said particular user according to said consumer preferences for said particular user.

13. The system for electronically managing shopping according to claim 12, said means for detecting a plurality of broadcasts of products in a common transmittable data format at a portable computer system, further comprising:
means for detecting said plurality of broadcasts of products in an extensible mark-up language data format.

14. The system for electronically managing shopping according to claim 12, said means for analyzing said plurality of broadcasts of products at said portable computer system according to consumer preferences for said particular user, further comprising:
means for analyzing said plurality of broadcasts of products in view of an electronic schedule of events stored on said portable computer system in association with said particular user.

15. The system for electronically managing shopping according to claim 12, said means for analyzing said plurality of broadcasts of products at said portable computer system according to consumer preferences for said particular user, further comprising:
means for analyzing said plurality of broadcasts of products in view of previously received product databases received at said portable computer system.

16. The system for electronically managing shopping according to claim 12, said means for analyzing said plurality of broadcasts of products at said portable computer system according to consumer preferences for said particular user, further comprising:
means for analyzing said plurality of broadcasts of products in view of travel distance from a current location to each of said plurality of diverse store locations.

17. The system for electronically managing shopping according to claim 12, said means for analyzing said plurality of broadcasts of products at said portable computer system according to consumer preferences for said particular user, further comprising:
means for analyzing said plurality of broadcasts of products according to a shopping robot application that searches said plurality of broadcasts of products and a plurality of network accessible web sites to return selections of a particular type of product to said particular user.

18. The system for electronically managing shopping according to claim 12, said means for controlling output of a selection of products from among said plurality of broadcasts of products to an output interface controlled by said portable computer system, further comprising:
means for controlling output of said selection of products to said output interface according to output preferences designated by said user on said portable computer system.

19. The system for electronically managing shopping according to claim 12, said system further comprising:
means for broadcasting a location of said portable computer system, in response to a user designation to broadcast said location, such that any of said plurality of retailer server systems within a particular proximity is enabled to detect said location of said portable computer system.

20. The system for electronically managing shopping according to claim 12, said system further comprising:
means for encrypting transmission of a location of said portable computer system, in response to a user designation to selectively transmit said location, such that only those server systems with a decryption key are enabled to detect said location of said portable computer system.

21. The system for electronically managing shopping according to claim 12, said system further comprising:
means for receiving a user request at said portable computer system for assistance in locating a particular venue-related item from among a plurality of venue-related items associated with a particular store location from among said plurality of diverse store locations;
means for searching said plurality of broadcasts of products received at said portable computer system for a location of said particular venue-related item;
means for comparing said location of said particular venue-related item with a current location of said portable computer system, in response to determining said location of said particular venue-related item; and
means for adjusting output of a graphical representation of directions for said user to reach said location of said particular venue-related item from said current location of said portable computer system.

22. The system for electronically managing shopping according to claim 12, said system further comprising:
means for receiving said consumer preferences at said portable computer system from a personal storage device proffered by said particular user.

23. A program for electronically managing shopping, residing on a computer usable medium having computer readable program code means, said program comprising:
means for detecting a plurality of broadcasts of products in a common transmittable data format at a portable computer system associated with a particular user from a plurality of retailer server systems when said portable computer system is within a particular proximity of a plurality of diverse store locations each respectively associated with one of said plurality of retailer server systems;
means for analyzing said plurality of broadcasts of products at said portable computer system according to consumer preferences for said particular user; and
means for controlling output of a selection of products from among said plurality of broadcasts of products to an output interface controlled by said portable computer system, in response to said analysis, such that said portable computer system manages product selections from said plurality of diverse store locations for said particular user according to said consumer preferences for said particular user.

24. The program for electronically managing shopping according to claim 23, said program further comprising means for detecting said plurality of broadcasts of products in an extensible mark-up language data format.

25. The program for electronically managing shopping according to claim 23, said program further comprising means for analyzing said plurality of broadcasts of products in view of an electronic schedule of events stored on said portable computer system in association with said particular user.

26. The program for electronically managing shopping according to claim 23, said program further comprising means for analyzing said plurality of broadcasts of products in view of previously received product databases received at said portable computer system.

27. The program for electronically managing shopping according to claim 23, said program further comprising means for analyzing said plurality of broadcasts of products in view of travel distance from a current location to each of said plurality of diverse store locations.

28. The program for electronically managing shopping according to claim 23, said program further comprising means for analyzing said plurality of broadcasts of products according to a shopping robot application that searches said plurality of broadcasts of products and a plurality of network accessible web sites to return selections of a particular type of product to said particular user.

29. The program for electronically managing shopping according to claim 23, said program further comprising means for controlling output of said selection of products to said output interface according to output preferences designated by said user on said portable computer system.

30. The program for electronically managing shopping according to claim 23, said program further comprising:
means for broadcasting a location of said portable computer system, in response to a user designation to broadcast said location, such that any of said plurality of retailer server systems within a particular proximity is enabled to detect said location of said portable computer system.

31. The program for electronically managing shopping according to claim 23, said program further comprising:
means for encrypting transmission of a location of said portable computer system, in response to a user designation to selectively transmit said location, such that only those server systems with a decryption key are enabled to detect said location of said portable computer system.

32. The program for electronically managing shopping according to claim 23, said program further comprising:
means for receiving a user request at said portable computer system for assistance in locating a particular venue-related item from among a plurality of venue-related items associated with a particular store location from among said plurality of diverse store locations; means for searching said plurality of broadcasts of products received at said portable computer system for a location of said particular venue-related item;
means for comparing said location of said particular venue-related item with a current location of said portable computer system, in response to determining said location of said particular venue-related item; and
means for adjusting output of a graphical representation of directions for said user to reach said location of said particular venue-related item from said current location of said portable computer system.

33. The program for electronically managing shopping according to claim 23, said program further comprising:
means for receiving said consumer preferences at said portable computer system from a personal storage device proffered by said particular user.

34. A method for managing product disbursement from a retailer, said method comprising the steps of:
filtering a database of products available from a particular retailer according to security preferences designated at a server system associated with said particular retailer; and
broadcasting said filtered database of products in a particular transmittable data format across a particular range, wherein a portable computer system within said particular range is able to retrieve said filtered database of products.

35. The method for managing product disbursement from a retailer according to claim 34, said step of filtering a database of products available from a particular retailer according to security preferences designated at a server system associated with said particular retailer, further comprising the step of:
filtering a plurality of positions associated with each of a plurality of products within said database of products according to said security preferences.

36. The method for managing product disbursement from a retailer according to claim 34, said step of filtering a database of products available from a particular retailer according to security preferences designated at a server system associated with said particular retailer, further comprising the step of:
filtering a plurality of positions associated with a plurality of staff within said database of products according to said security preferences.

37. The method for managing product disbursement from a retailer according to claim 34, said step of filtering a database of products available from a particular retailer according to security preferences designated at a server system associated with said particular retailer, further comprising the steps of:
detecting a location and registration indicator broadcast from said portable computer system;
comparing said registration indicator with a registration database; and
filtering said database of products available from a particular retailer according to whether or not said registration indicator is matched in said registration database.

38. The method for managing product disbursement from a retailer according to claim 34, said step of filtering a database of products available from a particular retailer according to security preferences designated at a server system associated with said particular retailer, further comprising the steps of:
detecting the transmission of the location of a plurality of global positioning system transceivers each associated with one of a plurality of venue-related items; and
updating said database of products with a plurality of detected locations of venue-related items according to said detected transmissions from said plurality of global positioning system transceivers.

39. The method for managing product disbursement from a retailer according to claim 38, said step of detecting the transmission of the location of a plurality of global positioning system transceivers further comprising the steps of:
detecting the transmission of encrypted locations of a plurality of global positioning system transceivers each associated with one of a plurality of venue-related items; and
decrypting said encrypted locations according to a particular decryption key at said server system.

40. The method for managing product disbursement from a retailer according to claim 34, said step of broadcasting said filtered database of products in a particular transmittable data format across a particular range, wherein a portable computer system within said particular range is able to retrieve said filtered database of products, further comprising the steps of:
transmitting said filtered database of products in said particular transmittable data format from said server system to a transceiver that broadcasts said filtered database of products within a particular range of said particular retailer associated with said filtered database of products.

41. A system for managing product disbursement from a retailer, said system comprising:
means for filtering a database of products available from a particular retailer according to security preferences designated at a server system associated with said particular retailer; and
means for broadcasting said filtered database of products in a particular transmittable data format across a particular range, wherein a portable computer system within said particular range is able to retrieve said filtered database of products.

42. The system for managing product disbursement from a retailer according to claim 41, said means for filtering a database of products available from a particular retailer according to security preferences designated at a server system associated with said particular retailer, further comprising:
means for filtering a plurality of positions associated with each of a plurality of products within said database of products according to said security preferences.

43. The system for managing product disbursement from a retailer according to claim 41, said means for filtering a database of products available from a particular retailer according to security preferences designated at a server system associated with said particular retailer, further comprising:
means for filtering a plurality of positions associated with a plurality of staff within said database of products according to said security preferences.

44. The system for managing product disbursement from a retailer according to claim 41, said means for filtering a database of products available from a particular retailer according to security preferences designated at a server system associated with said particular retailer, further comprising:
means for detecting a location and registration indicator broadcast from said portable computer system;
means for comparing said registration indicator with a registration database; and
means for filtering said database of products available from a particular retailer according to whether or not said registration indicator is matched in said registration database.

45. The system for managing product disbursement from a retailer according to claim 41, said means for filtering a database of products available from a particular retailer according to security preferences designated at a server system associated with said particular retailer, further comprising:
means for detecting the transmission of the location of a plurality of global positioning system transceivers each associated with one of a plurality of venue-related items; and
means for updating said database of products with a plurality of detected locations of venue-related items according to said detected transmissions from said plurality of global positioning system transceivers.

46. The system for managing product disbursement from a retailer according to claim 45, said means for detecting the transmission of the location of a plurality of global positioning system transceivers further comprising:
means for detecting the transmission of encrypted locations of a plurality of global positioning system transceivers each associated with one of a plurality of venue-related items; and
means for decrypting said encrypted locations according to a particular decryption key at said server system.

47. The system for managing product disbursement from a retailer according to claim 41, said means for broadcasting said filtered database of products in a particular transmittable data format across a particular range, wherein a portable computer system within said particular range is able to retrieve said filtered database of products, further comprising:
means for transmitting said filtered database of products in said particular transmittable data format from said server system to a transceiver that broadcasts said filtered database of products within a particular range of said particular retailer associated with said filtered database of products.
